(19) United States
(12) Patent Application Publication
(10) Pub. No.: US 2025/0269767 A1
(43) Pub. Date: Aug. 28, 2025

(54) Electric flip seat for golf cart, and golf cart

(71) Applicant: Ji Xia Auto Technology Co., Ltd., Taicang (CN)

(72) Inventor: Lamei SHI, Taicang (CN)

(73) Assignee: Ji Xia Auto Technology Co., Ltd., Taicang (CN)

(21) Appl. No.: 18/985,037

(22) Filed: Dec. 18, 2024

(30) Foreign Application Priority Data
Feb. 27, 2024 (CN) 202410210625.4

(51) Int. Cl. B60N 2/02; B60R 9/08

(52) U.S. Cl. CPC B60N 2/02246; B60R 9/08

(57) ABSTRACT

An electric flip seat for a golf cart, and a golf cart are provided. The electric flip seat for a golf cart includes a seat cushion provided on a first flip part including a first rotatable frame, a first driving device, and a first fixed frame; a rotation spindle of the first rotatable frame corresponds to an inner side position of the seat cushion in a depth direction; the seat cushion is provided on the first rotatable frame; the first rotatable frame is rotatably connected to the first fixed frame; when the first flip part is in a reset state, the first rotatable frame is flat, and the seat cushion is configured to sit a person; and the first driving device is configured to drive the first rotatable frame to flip around the rotation spindle to raise the seat cushion and an outer side of the first rotatable frame.

### CROSS REFERENCE TO THE RELATED APPLICATIONS

This application is based upon and claims priority to Chinese Patent Application No. 202410210625.4, filed on Feb. 27, 2024, the entire contents of which are incorporated herein by reference.

### TECHNICAL FIELD

The present disclosure relates to the technical field of car seat manufacturing, and in particular to an electric flip seat for a golf cart, and a golf cart.

### BACKGROUND

In existing car seats, there is usually a ground clearance between the bottom of the seat cushion and the bottom of the car, and there is not a high utilization of space under the seat. If items are placed under the seat, it is inconvenient to retrieve and place them, especially for a golf cart with a small size. In order to improve space utilization, it is necessary to comprehensively utilize various spaces on the golf cart, including the space under the seat, such as to place items or design an inspection port under the seat. When retrieving items under the seat or conducting maintenance through the inspection port, it often interferes with the seat. Especially during maintenance, it is often necessary to remove the seat. Therefore, it is not convenient in utilizing the space under the seat.

### SUMMARY

To overcome the aforementioned shortcomings of the prior art, the present disclosure provides an electric flip seat for a golf cart, which enhances the convenience of utilizing the space under the seat.

The above objective of the present disclosure is achieved by the following technical solutions:

An electric flip seat for a golf cart includes a seat cushion, where the seat cushion is mounted on a first flip part; the first flip part includes a first rotatable frame; a rotation spindle of the first rotatable frame corresponds to an inner side position of the seat cushion in a depth direction; the seat cushion is provided on the first rotatable frame; the first flip part further includes a first driving device; the first driving device is connected in a driving manner to the first rotatable frame; the first flip part further includes a first fixed frame; the first fixed frame is configured to connect a cart body; the first rotatable frame is rotatably connected to the first fixed frame; when the first flip part is in a reset state, the first rotatable frame is flat, and the seat cushion provided on the first rotatable frame is configured to sit a person; and the first driving device is configured to drive the first rotatable frame to flip around the rotation spindle of the first rotatable frame, so as to raise the seat cushion and an outer side of the first rotatable frame.

Based on the above structure, in the electric flip seat for a golf cart, the seat cushion can be flipped a preset angle with the first flip part until the space under the seat cushion and the first rotatable frame is opened. In this way, it is convenient to utilize the space, such as placing items in the space or conducting maintenance through an inspection port under the seat. The design enhances the convenience of utilizing the space under the seat.

Furthermore, in the electric flip seat for a golf cart according to the present disclosure, the first flip part further includes a first angle adjuster; and the first angle adjuster is located between the first rotatable frame and the first fixed frame. In a preferred solution of the present disclosure, the angle adjuster is usually provided on a rotatable frame of a car seat back, such that the seat back can still bear an external force after angle adjustment. The first angle adjuster corresponds to a rotational joint between the first rotatable frame and the first fixed frame. When the first rotatable frame rotates until the outer side thereof is raised, the first angle adjuster provides a locking force to prevent the first rotatable frame from rotating relative to the first fixed frame due to its own gravity or an external force when the first driving device stops working. Thus, the first rotatable frame can stop after rotating to any angle.

Furthermore, in the electric flip seat for a golf cart according to the present disclosure, the first rotatable frame is provided with a golf bag locking device for locking a golf bag at a side of the first rotatable frame away from the seat cushion. In a preferred solution of the present disclosure, specifically, the golf bag locking device can be a strap or a hoop.

Furthermore, in the electric flip seat for a golf cart according to the present disclosure, a posture of the golf bag locked at the side of the first rotatable frame away from the seat cushion is parallel to the depth direction of the seat cushion, and an opening of the golf bag faces outward. In a preferred solution of the present disclosure, based on the above structure, when the electric flip seat for a golf cart of the present disclosure is applied to a golf cart, if the first flip part is in the reset state, the seat cushion can be used for sitting. After the first rotatable frame flips, the golf bag can be placed at the side of the first rotatable frame away from the seat cushion. The design can achieve two functions: sitting a person and hanging a golf bag. It should be noted that a golf club is placed in the golf bag, with a club grip exposed from an open end of the golf bag. To extract the golf club from the golf bag, it needs to be pulled out from bottom to top. Based on the above structure, the first rotatable frame is able to flip a preset angle and the golf bag is locked at the side of the first rotatable frame away from the seat cushion. Therefore, it is possible to adjust the height of the club grip inside the golf bag, making it convenient for the user to pull out the golf club diagonally from the golf bag. In addition, the tilt angle of the golf bag is adjustable according to the user's usage habit and comfort, so as to facilitate the operation of pulling out the golf club.

Furthermore, in the electric flip seat for a golf cart according to the present disclosure, the first rotatable frame includes a first articulated frame; the first articulated frame is rotatably connected to the first fixed frame; the first rotatable frame further includes a first bearing plate; the first bearing plate is mounted on the first articulated frame; and the first bearing plate is configured to mount the seat cushion. In a preferred solution of the present disclosure, specifically, the first articulated frames are arranged in pairs at two sides of the first rotatable frame. The first articulated frame is connected to the rotatable mounting plate of the first angle adjuster.

Furthermore, in the electric flip seat for a golf cart according to the present disclosure, the electric flip seat for a golf cart further includes a second flip part; the second flip part includes a second rotatable frame; the second rotatable frame is rotatably provided on the first rotatable frame; a rotation spindle of the second rotatable frame is located at an outer side of the first rotatable frame in a depth direction; the seat cushion is provided on the second rotatable frame; the second flip part further includes a second driving device; the second driving device is connected in a driving manner to the second rotatable frame; when the second flip part is in a reset state, the second rotatable frame is stacked on the first rotatable frame, and the seat cushion is located above the second rotatable frame; and the second driving device is configured to drive the second rotatable frame to flip to the outer side of the first rotatable frame. In a preferred solution of the present disclosure, specifically, the second driving devices can drive the second rotatable frame to flip 180 degrees from the reset state, such that the seat cushion faces downwards, and a side of the second rotatable frame away from the seat cushion and an upper end of the first driving device form a storage platform.

Furthermore, in the electric flip seat for a golf cart according to the present disclosure, the second flip part further includes a connecting frame; the connecting frame is mounted on the first rotatable frame; the second rotatable frame is rotatably connected to the connecting frame; and a second angle adjuster is provided between the connecting frame and the second rotatable frame.

A golf cart includes the electric flip seat for a golf cart and a cart body, where the first fixed frame is provided on the cart body.

Furthermore, in the golf cart, the cart body is provided with an inspection port; and when the first flip part is in the reset state, the inspection port is located below the first rotatable frame. In a preferred solution of the present disclosure, when maintenance is required, the first driving device flips up the first rotatable frame for ease of maintenance.

Furthermore, in the golf cart, a front side of the electric flip seat for a golf cart is provided with a handrail frame; the handrail frame is mounted on the cart body; the handrail frame is provided with a support rod; the second rotatable frame is provided with a lap frame; and the second driving device is configured to drive the second rotatable frame to flip such that the lap frame is lapped on an upper end of the support rod. In a preferred solution of the present disclosure, when the second rotatable frame is in an outward flip state, the support rod supports an outer end of the second rotatable frame to improve the load-bearing capacity and stability of the second rotatable frame after flipping.

As can be seen from the above technical solutions, the present disclosure has the following beneficial effects:

1. In the electric flip seat for a golf cart provided by the present disclosure, the seat cushion can be flipped a preset angle with the first flip part until the space under the seat cushion and the first rotatable frame is opened. In this way, it is convenient to utilize the space, such as placing items in the space or conducting maintenance through an inspection port under the seat. The design enhances the convenience of utilizing the space under the seat.

2. When the electric flip seat for a golf cart of the present disclosure is applied to a golf cart, if the first flip part is in the reset state, the seat cushion can be used for sitting. After the first rotatable frame flips, the golf bag can be placed at the side of the first rotatable frame away from the seat cushion. The design can achieve two functions: sitting a person and hanging a golf bag. It should be noted that a golf club is placed in the golf bag, with a club grip exposed from an open end of the golf bag. To extract the golf club from the golf bag, it needs to be pulled out from bottom to top. Based on the above structure, the first rotatable frame is able to flip a preset angle and the golf bag is locked at the side of the first rotatable frame away from the seat cushion. Therefore, it is possible to adjust the height of the club grip inside the golf bag, making it convenient for the user to pull out the golf club diagonally from the golf bag. In addition, the tilt angle of the golf bag is adjustable according to the user's usage habit and comfort, so as to facilitate the operation of pulling out the golf club.

3. In the electric flip seat for a golf cart provided by the present disclosure, the first angle adjuster corresponds to a rotational joint between the first rotatable frame and the first fixed frame. When the first rotatable frame rotates until the outer side thereof is raised, the first angle adjuster provides a locking force to prevent the first rotatable frame from rotating relative to the first fixed frame due to its own gravity or an external force when the first driving device stops working. Thus, the first rotatable frame can stop after rotating to any angle.

### BRIEF DESCRIPTION OF THE DRAWINGS

FIG. 1 is a schematic diagram showing that a first flip part and a second flip part of an electric flip seat for a golf cart are in a reset state according to an embodiment of the present disclosure;

FIG. 2 is a schematic diagram of the first flip part and the second flip part according to the embodiment of the present disclosure;

FIG. 3 is a schematic diagram of components of the first flip part according to the embodiment of the present disclosure;

FIG. 4 is a schematic diagram showing that a first rotatable frame of the electric flip seat for a golf cart is in a flip state according to the embodiment of the present disclosure;

FIG. 5 is a schematic diagram showing that a second rotatable frame of the electric flip seat for a golf cart flips such that a lap frame laps on an upper end of a handrail frame according to the embodiment of the present disclosure; and

FIG. 6 is a schematic diagram of components of the second flip part of the electric flip seat for a golf cart according to the embodiment of the present disclosure.

Reference Numerals: 1. seat cushion;

2. first flip part; 21. first rotatable frame; 211. first articulated frame; 212. first bearing plate; 22. first driving device; 23. first fixed frame; 24. first angle adjuster; and 241. first driving shaft;

3. second flip part; 31. second rotatable frame; 311. second articulated frame; 312. second bearing plate; 313. lap frame; 33. connecting frame; and 34. second angle adjuster;

4. cart body; and 41. control button; and

5. handrail frame; and 51. support rod.

### DETAILED DESCRIPTION OF THE EMBODIMENTS

### Embodiment 1

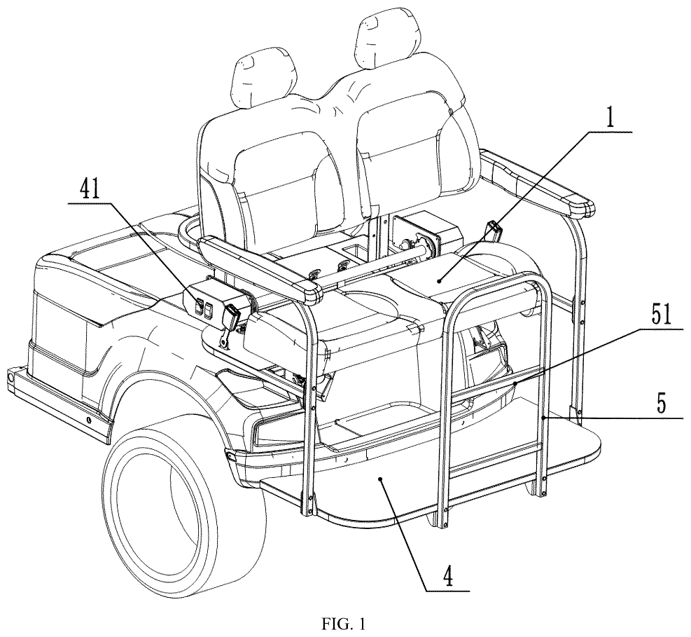

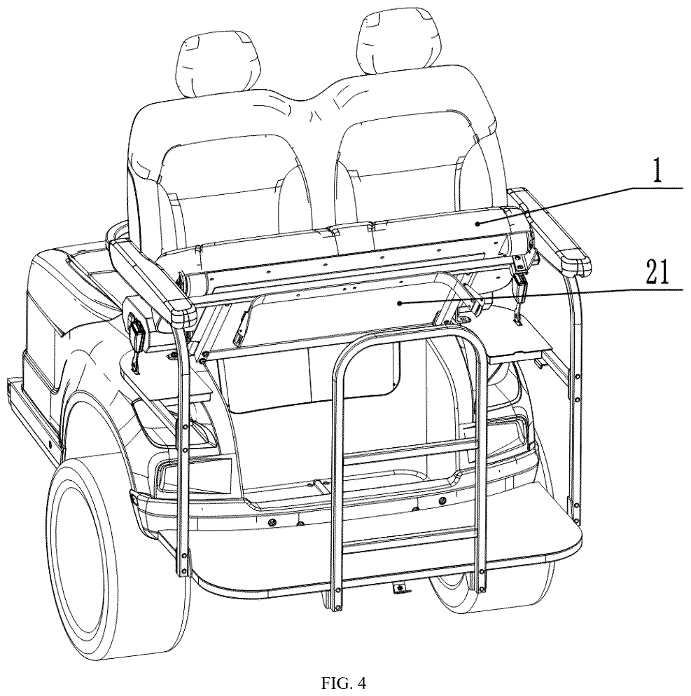

As shown in FIGS. 1 to 4, an electric flip seat for a golf cart includes seat cushion 1. The seat cushion 1 is mounted on first flip part 2. The first flip part 2 includes first rotatable frame 21. A rotation spindle of the first rotatable frame 21 corresponds to an inner side position of the seat cushion 1 in a depth direction. The seat cushion 1 is provided on the first rotatable frame 21. The first flip part 2 further includes first driving devices 22. The first driving device 22 is connected in a driving manner to the first rotatable frame 21. The first flip part 2 further includes first fixed frame 23. The first fixed frame 23 is configured to connect a cart body. The first rotatable frame 21 is rotatably connected to the first fixed frame 23. When the first flip part 2 is in a reset state, as shown in FIG. 1, the first rotatable frame 21 is flat, and the seat cushion 1 provided on the first rotatable frame 21 is configured to sit a person. The first driving device 22 is configured to drive the first rotatable frame 21 to flip around the rotation spindle of the first rotatable frame, so as to raise the seat cushion 1 and an outer side of the first rotatable frame 21, as shown in FIG. 4.

In existing car seats, there is usually a ground clearance between the bottom of the seat cushion and the bottom of the car, and the space utilization under the seat is not high. If items are placed under the seat, it is inconvenient to retrieve and place them, especially for a golf cart with a small size. In order to improve space utilization, it is necessary to comprehensively utilize various spaces on the golf cart, including the space under the seat, such as to place items or design an inspection port under the seat. When retrieving items under the seat or conducting maintenance through the inspection port, it often interferes with the seat. Especially during maintenance, it is often necessary to remove the seat. Therefore, it is not convenient to utilize the space under the seat.

Based on the above structure, in the electric flip seat for a golf cart, the seat cushion 1 can be flipped a preset angle with the first flip part 2 until the space under the seat cushion 1 and the first rotatable frame 21 is opened. In this way, it is convenient to utilize the space, such as placing items in the space or conducting maintenance through an inspection port under the seat. The design enhances the convenience of utilizing the space under the seat.

In this embodiment, a driving body of the first driving device 22 is a motor. When the first flip part 2 is in the reset state, there is a cavity below the first rotatable frame 21, that is, there is a preset clearance between the first rotatable frame 21 and an upper end of a bottom of the golf cart.

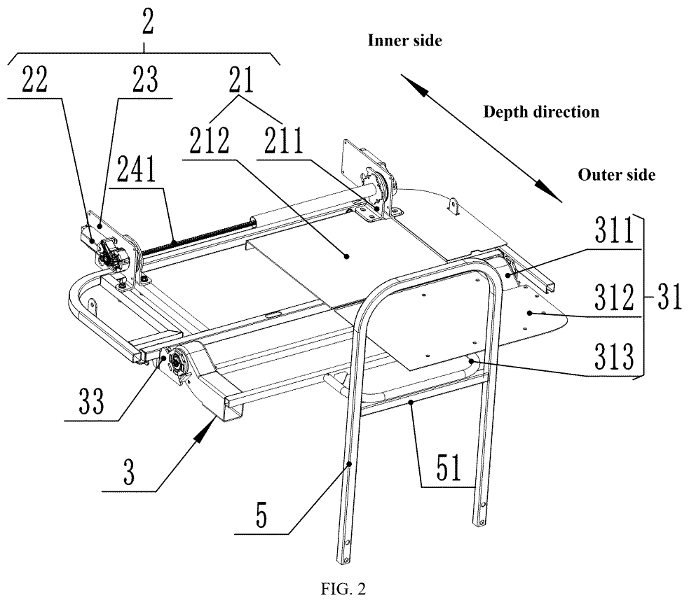

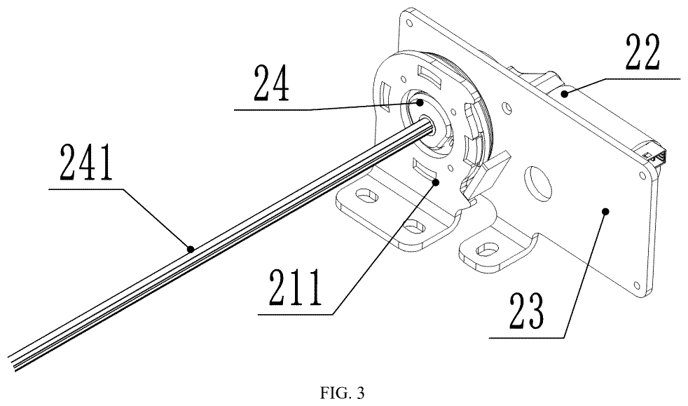

As shown in FIGS. 2 and 3, in this embodiment, the first flip part 2 further includes first angle adjusters 24. The first angle adjuster 24 is located between the first rotatable frame 21 and the first fixed frame 23. The angle adjuster is usually provided on a rotatable frame of a car seat back, such that the seat back can still bear an external force after angle adjustment. The first angle adjuster 24 corresponds to a rotational joint between the first rotatable frame 21 and the first fixed frame 23. When the first rotatable frame 21 rotates until the outer side thereof is raised, the first angle adjuster 24 provides a locking force to prevent the first rotatable frame 21 from rotating relative to the first fixed frame 23 due to its own gravity or an external force when the first driving device 22 stops working. Thus, the first rotatable frame 21 can stop after rotating to any angle. The mounting principle of the angle adjuster is as follows. The angle adjuster is provided with a rotatable mounting plate and a fixed mounting plate. The rotatable mounting plate and the fixed mounting plate are respectively connected to the rotatable frame and the fixed frame. The rotatable mounting plate of the angle adjuster is provided with a driving shaft corresponding to an output shaft of the driving device. Specifically, in this embodiment, the rotatable mounting plate of the first angle adjuster 24 is connected to the first rotatable frame 21. The fixed mounting plate of the first angle adjuster 24 is connected to the first fixed frame 23. The first angle adjusters 24 and the first driving devices 22 both are arranged in pairs at two sides of the seat cushion 1. The rotatable mounting plates of the two first angle adjusters 24 share one first driving shaft 241. The first driving shaft 241 corresponds to output shafts of the two first driving devices 22. The first driving device 22 is provided on the first fixed frame 23.

In this embodiment, the first rotatable frame 21 is provided with a golf bag locking device (not shown in the figure) for locking a golf bag at a side of the first rotatable frame 21 away from the seat cushion 1. Specifically, the golf bag locking device can be a strap or a hoop.

In this embodiment, a posture of the golf bag locked at the side of the first rotatable frame 21 away from the seat cushion 1 is parallel to the depth direction of the seat cushion 1, and an opening of the golf bag faces outward. Based on the above structure, when the electric flip seat for a golf cart of the present disclosure is applied to a golf cart, if the first flip part 2 is in the reset state, the seat cushion 1 can be used for sitting. After the first rotatable frame 21 flips, the golf bag can be placed at the side of the first rotatable frame 21 away from the seat cushion 1. The design can achieve two functions: sitting a person and hanging a golf bag. It should be noted that a golf club is placed in the golf bag, with a club grip exposed from an open end of the golf bag. To extract the golf club from the golf bag, it needs to be pulled out from bottom to top. Based on the above structure, the first rotatable frame 21 is able to flip a preset angle and the golf bag is locked at the side of the first rotatable frame 21 away from the seat cushion 1. Therefore, it is possible to adjust the height of the club grip inside the golf bag, making it convenient for the user to pull out the golf club diagonally from the golf bag. In addition, the tilt angle of the golf bag is adjustable according to the user's usage habit and comfort, so as to facilitate the operation of pulling out the golf club.

As shown in FIGS. 2 and 3, in this embodiment, the first rotatable frame 21 includes first articulated frames 211. The first articulated frame 211 is rotatably connected to the first fixed frame 23. The first rotatable frame 21 further includes first bearing plate 212. The first bearing plate 212 is mounted on the first articulated frame 211. The first bearing plate 212 is configured to mount the seat cushion 1. Specifically, the first articulated frames 211 are arranged in pairs at two sides of the first rotatable frame 21. The first articulated frame 211 is connected to the rotatable mounting plate of the first angle adjuster 24. The golf bag locking device (not shown in the figure) is located at the side of the first bearing plate 212 away from the seat cushion 1.

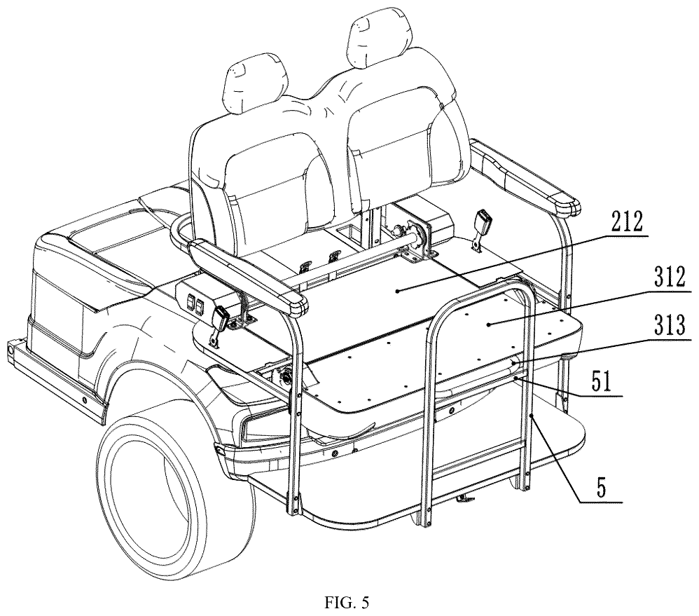

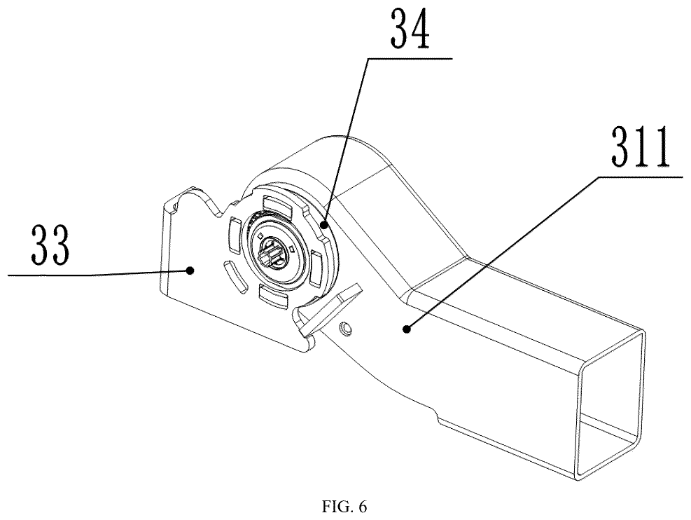

As shown in FIGS. 2, 5, and 6, in this embodiment, the electric flip seat for a golf cart further includes second flip part 3. The second flip part 3 includes second rotatable frame 31. The second rotatable frame 31 is rotatably provided on the first rotatable frame 21. A rotation spindle of the second rotatable frame 31 is located at an outer side of the first rotatable frame 21 in a depth direction. The seat cushion 1 is provided on the second rotatable frame 31. The second flip part 3 further includes second driving devices (not shown in the figure). The second driving devices are connected in a driving manner to the second rotatable frame 31. When the second flip part 3 is in a reset state, as shown in FIG. 1, the second rotatable frame 31 is stacked on the first rotatable frame 21, and the seat cushion 1 is located above the second rotatable frame 31. As shown in FIG. 5, the second driving devices can drive the second rotatable frame 31 to flip to the outer side of the first rotatable frame 21. Specifically, the second driving devices can drive the second rotatable frame 31 to flip 180 degrees from the reset state, such that the seat cushion 1 faces downwards, and a side of the second rotatable frame 31 away from the seat cushion 1 and an upper end of the first driving device 22 form a storage platform.

As shown in FIGS. 2, 3, and 6, in this embodiment, the second flip part 3 includes connecting frame 33. The connecting frame 33 is mounted on the first rotatable frame 21. The second rotatable frame 31 is rotatably connected to the connecting frame 33. Second angle adjuster 34 is provided between the connecting frame 33 and the second rotatable frame 31. Specifically, the rotatable mounting plate of the second angle adjuster 34 is connected to the connecting frame 33. The fixed mounting plate of the second angle adjuster 34 is connected to the second rotatable frame 31. The second driving devices are provided on the second rotatable frame 31. A driving body of the second driving device is a motor. A driving shaft on the rotatable mounting plate of the second angle adjuster 34 corresponds to the output shaft of the second driving device. The second driving devices are arranged in pairs. The second rotatable frame 31 includes second articulated frame 311 and second bearing plate 312. The second bearing plate 312 is provided on the second articulated frame 311. The second articulated frame 311 is rotatably connected to the connecting frame 33 through the second angle adjuster 34.

### Embodiment 2

As shown in FIGS. 1 to 6, a golf cart includes the electric flip seat for a golf cart according to Embodiment 1. The golf cart includes cart body 4. The first fixed frame 23 is provided on the cart body 4. In this embodiment, the electric flip seat for a golf cart according to Embodiment 1 is provided at a rear end of the cart body 4. The cart body 4 is provided with control button 41 for driving the first driving device 22 and the second driving device.

In this embodiment, the cart body 4 is provided with an inspection port (not shown in the figure). When the first flip part 2 is in the reset state, the inspection port is located below the first rotatable frame 21. When maintenance is required, the first driving device 22 flips up the first rotatable frame 21 for ease of maintenance.

In this embodiment, a front side of the electric flip seat for a golf cart is provided with handrail frame 5. The handrail frame 5 is mounted on the cart body 4. The handrail frame 5 is provided with support rod 51. The second rotatable frame 31 is provided with lap frame 313. The second driving device drives the second rotatable frame 31 to flip such that the lap frame 313 is lapped on an upper end of the support rod 51. When the second rotatable frame 31 is in an outward flip state, the support rod 51 supports an outer end of the second rotatable frame 31 to improve the load-bearing capacity and stability of the second rotatable frame 31 after flipping. Specifically, when the second rotatable frame 31 flips such that the lap frame 313 is lapped on the support rod 51, the second bearing plate 312 and the first bearing plate 212 are in a same plane.

The technical principles of the present disclosure are described with reference to the specific embodiments. The description is merely intended to explain the principles of the present disclosure, rather than to limit the protection scope of the present disclosure in any way. Based on the explanation herein, those skilled in the art may derive other specific implementations of the present disclosure without creative effort, but these implementations should fall within the protection scope of the present disclosure.

What is claimed is:

1. An electric flip seat for a golf cart, comprising a seat cushion, wherein the seat cushion is mounted on a first flip part; the first flip part comprises a first rotatable frame; a rotation spindle of the first rotatable frame corresponds to an inner side position of the seat cushion in a depth direction; the seat cushion is provided on the first rotatable frame; the first flip part further comprises a first driving device; the first driving device is connected in a driving manner to the first rotatable frame; the first flip part further comprises a first fixed frame; the first fixed frame is configured to connect a cart body; and the first rotatable frame is rotatably connected to the first fixed frame;
when the first flip part is in a reset state, the first rotatable frame is flat, and the seat cushion provided on the first rotatable frame is configured to sit a person; and
the first driving device is configured to drive the first rotatable frame to flip around the rotation spindle of the first rotatable frame, to raise the seat cushion and an outer side of the first rotatable frame.

2. The electric flip seat for the golf cart according to claim 1, wherein the first flip part further comprises a first angle adjuster; and the first angle adjuster is located between the first rotatable frame and the first fixed frame.

3. The electric flip seat for the golf cart according to claim 1, wherein the first rotatable frame is provided with a golf bag locking device for locking a golf bag at a side of the first rotatable frame away from the seat cushion.

4. The electric flip seat for the golf cart according to claim 3, wherein a posture of the golf bag locked at the side of the first rotatable frame away from the seat cushion is parallel to the depth direction of the seat cushion, and an opening of the golf bag faces outward.

5. The electric flip seat for the golf cart according to claim 1, wherein the first rotatable frame comprises a first articulated frame; the first articulated frame is rotatably connected to the first fixed frame; the first rotatable frame further comprises a first bearing plate; the first bearing plate is mounted on the first articulated frame; and the first bearing plate is configured to mount the seat cushion.

6. The electric flip seat for the golf cart according to claim 1, further comprising a second flip part, wherein the second flip part comprises a second rotatable frame; the second rotatable frame is rotatably provided on the first rotatable frame; a rotation spindle of the second rotatable frame is located at the outer side of the first rotatable frame in a depth direction; the seat cushion is provided on the second rotatable frame; the second flip part further comprises a second driving device; and the second driving device is connected in the driving manner to the second rotatable frame;
when the second flip part is in the reset state, the second rotatable frame is stacked on the first rotatable frame, and the seat cushion is located above the second rotatable frame; and
the second driving device is configured to drive the second rotatable frame to flip to the outer side of the first rotatable frame.

7. The electric flip seat for the golf cart according to claim 6, wherein the second flip part comprises a connecting frame; the connecting frame is mounted on the first rotatable frame; the second rotatable frame is rotatably connected to the connecting frame; and a second angle adjuster is provided between the connecting frame and the second rotatable frame.

8. A golf cart, comprising the electric flip seat for the golf cart according to claim 6 and the cart body, wherein the first fixed frame is provided on the cart body.

9. The golf cart according to claim 8, wherein the cart body is provided with an inspection port; and when the first flip part is in the reset state, the inspection port is located below the first rotatable frame.

10. The golf cart according to claim 8, wherein a front side of the electric flip seat for the golf cart is provided with a handrail frame; the handrail frame is mounted on the cart body; the handrail frame is provided with a support rod; the second rotatable frame is provided with a lap frame; and the second driving device is configured to drive the second rotatable frame to flip, wherein the lap frame is lapped on an upper end of the support rod.
